(19) United States
(12) Patent Application Publication
(10) Pub. No.: US 2019/0061994 A1
(43) Pub. Date: Feb. 28, 2019

(54) WOODEN CASK AND MODULE FOR STORING AND AGING WINE AND OTHER BEVERAGES

(71) Applicant: Cyrille Savioz, Arbaz (CH)

(72) Inventor: Cyrille Savioz, Arbaz (CH)

(21) Appl. No.: 15/774,316

(22) PCT Filed: Nov. 7, 2016
(86) PCT No.: PCT/IB2016/056687

§ 371 Date: May 8, 2018

(30) Foreign Application Priority Data
Nov. 9, 2015 (CH) 01624/15

(51) Int. Cl. B65D 6/02; B65D 6/16; B65D 6/34; C12H 1/22

(52) U.S. Cl. CPC B65D 9/06; C12H 1/22; B65D 9/34; B65D 9/12

(57) ABSTRACT

A wooden cask for storing and aging wine and other beverages including four side panels, a bottom panel and a top panel. The panels are provided with substantially planar outer and inner surfaces joined to one another so as to define an internal storage volume. Vertical beams form buttresses against the outer surfaces of at least two opposite side panels. The two ends of the beams project beyond the bottom and top edges of the side panel against which same are fitted, such that the casks may be stacked by placing the beams thereof one on top of the other without the side walls of the stacked casks touching one another.

### TECHNICAL FIELD

The present invention relates to a cask for beverages, in particular a substantially parallelepiped wooden cask. The present invention also relates to a storage unit forming a module with several casks.

### PRIOR ART

Cubical wooden casks for the storage of wine, spirits, and other beverages are known. As compared to ordinary oval barrels, they have the advantage of being more easily stacked and making more efficient use of the available storage volumes.

U.S. Pat. No. 4,093,099 describes a cask of substantially cubical shape for the aging of wine, whose assembly requires one spar and one metallic rod along each edge. The fabrication is costly, and the mounting of these twelve spars and twelve rods is hard to accomplish. The weight of the twelve spars is added to that of the six panels. Furthermore, the presence of projecting screws on all the faces of this cask makes their stacking impossible.

EP 1954575 describes a parallelepiped wooden cask for the storage and aging of wine. A compression element tends to bring together spars on the external faces of four panels in an oblique direction with respect to the panels. Such a compression element is complex in its fabrication and its mounting, and relatively costly. Furthermore, the stacking of these casks is unstable; the casks placed one on top of the other in fact rest on the edge of the lateral panels, which is necessarily relatively thin in order to limit the weight of the cask.

The cask described in application EP929477 comprises in particular six panels assembled by means of spars on four faces. Two opposite spars are joined by means of long metal rods extending in parallel with the spars on the top and bottom panels. The force of compression exerted by the screws tends to bring the two lateral panels closer together, but does not prevent the deformation of the bottom and top panels, which are poorly maintained. The stacking is done by placing the lateral panels one on top of the other on their edge, which does not allow for sufficient stability.

Other solutions for the assembly of panels exist, but they are poorly suited to parallelepiped casks, or they do not allow a fine tuning of the pressure exerted on each face. Such a fine tuning, however, is indispensable for wooden casks, which need to be absolutely tight despite wooden machining tolerances and deformations thereof resulting from the aging and the variations of temperature and humidity.

Moreover, such casks need to be able to withstand additional forces due to the weight of casks placed one on another, especially on the casks at the bottom of the stack.

Furthermore, another problem often encountered is the difficulty of handling once several casks have been stacked one on another.

### BRIEF SUMMARY OF THE INVENTION

One purpose of the present invention is to propose a parallelepiped wooden cask, especially a substantially cubical one, for the storage of wines, spirits, and other beverages, which does not present the problems of the casks of the prior art.

According to the invention, this purpose is achieved thanks to a wooden cask for the storing and aging of wines and other beverages, comprising:

four lateral panels;

a lower panel;

an upper panel;

said panels being provided with external and internal substantially planar faces and being assembled together so as to define an internal storage volume,

vertical beams forming a buttress against the external faces of at least two opposite lateral panels,

the two ends of said beams extending beyond the lower and upper edges of the lateral panel against which they are mounted. In this way, one may stack casks by placing the beams of the casks on top of one another without the lateral walls of the casks so placed on top of one another touching each other and, more generally, without the panels of adjacent casks, especially those placed on top of one another, touching each other.

This solution presents the advantage, in particular, of allowing an easy and stable stacking of casks; the upper casks in fact rest by the base of their beams on the upper face of the beams of the lower casks.

The vertical beams serve in the first place as a buttress to prevent the deformation of the lateral walls of the cask against which they are bearing.

The vertical beams likewise serve as pillars to support the entire weight of the casks placed one on another, which thus do not rest on the lateral panels.

At least two opposite vertical beams may be assembled together. Preferably, this assembly is done by means of at least one compression element passing through a lower or upper panel perpendicular to said beams, thus exerting a horizontal force tending to bring together said opposite vertical beams and the opposite lateral panels against which these beams rest.

In one embodiment, each vertical beam forming a buttress is connected by at least one compression element to a vertical beam against the opposite lateral panel.

In one embodiment, each vertical beam forming a buttress is connected by at least two compression elements to a vertical beam against the opposite lateral panel.

This solution presents the advantage in particular of a tight structure thanks to the horizontal force of compression obtained thanks to the compression elements.

This solution also presents the advantage of a particularly stable structure thanks to the compression elements. In particular, the stability of the vertical beams is guaranteed thanks to their connection in pairs and their bearing against the panels. Advantageously, these compression elements are linear elements placed under tension by their two ends when a traction force is exerted on each of these ends.

This solution also enables a very easy mounting and regulating of the pressure on each face. In fact, each compression element exerts a force simultaneously on several panels, tending to bring them closer to the internal volume. The adjusting of a single compression element thus allows acting simultaneously on several adjacent panels.

In one embodiment, each compression element passes through a through hole through the width of a panel without reaching the internal volume.

The vertical beams being prolonged upward and downward, a space exists between the panels of casks placed one on another. This space allows the introduction of lifting means, such as the fork of a forklift, which makes the handling of the casks easier.

In one embodiment, the extension of the beams beyond each end is between 0.5 and 12.5 cm, preferably between 0.5 and 10 cm, preferably between 0.5 and 7.5 cm, advantageously 5 cm.

In one embodiment, the beams are pierced at each end portion by a through hole, the axis of the hole being horizontal. A seat for a screw head may be provided at the external end of the through hole.

The compression element may comprise a tube threaded at its ends and two clamping screws.

The compression element may comprise a rod threaded at its ends and two nuts.

In one embodiment, the vertical beams comprise a first end with a tenon and a second end with a mortise having a shape complementary to the tenon. This advantageous arrangement enables easier centering of the casks during their stacking.

In one embodiment, the six panels are fitted together by their edges, for example by means of a tenon and mortise joint.

The invention also relates to an assembly of casks as previously described, comprising at least two casks held together side by side by U-shaped elements arranged upside down astride the edge of a panel of each cask.

The invention also relates to an assembly of casks where at least one cask is stacked on top of another cask.

The invention also relates to a storage unit bounding several casks placed together along a horizontal line.

Such a wooden storage unit bounds a series of several casks for the storing and aging of wines and other beverages, each cask comprising:

four lateral panels;

a lower panel;

an upper panel;

said panels being provided with external and internal substantially planar faces and being assembled together so as to define an internal storage volume,

said casks being adjacent and aligned with each other,

said storage unit further comprising at least two vertical beams forming a buttress against the external faces of the two opposite lateral panels directed toward the outside of the storage unit,

and the two ends of said vertical beams extend beyond the lower edges and/or the upper edges of the lateral panel against which they are mounted. In this way, one may stack casks by placing storage units on top of one another between them, placing beams of the storage units on top of one another, without the lateral walls of the casks so placed on top of one another touching each other. In certain configurations, one may stack casks by placing storage units on top of one another between them, without the lateral walls of the adjacent casks touching each other. In certain configurations, one may stack casks by placing storage units on top of one another between them, without any of the panels of the adjacent casks, especially those placed one on top of the other, touching each other.

According to one possible and advantageous arrangement regarding the cask according to the invention and also the multiple-cask storage unit according to the invention, the cask (the storage unit) further comprises compression elements in order to assemble each vertical beam to an opposite vertical beam. Preferably, these compression elements pass through a piece of said vertical beams, especially an end piece. Advantageously, each pair of opposite vertical beams is assembled by a pair of compression elements, one compression element being mounted on the lower end portion of the opposite vertical beams and another compression element being mounted on the upper end portion of the opposite vertical beams.

### BRIEF DESCRIPTION OF THE FIGURES

Sample embodiments of the invention are indicated in the description illustrated by the enclosed figures, in which:

FIG. 1 illustrates a partial perspective view of a cask according to the invention.

FIG. 2 illustrates a perspective view of a cask according to the invention.

FIG. 3a illustrates a perspective view of a cask according to the invention.

FIGS. 3b and 3c show in cross section details of the assembly between the panels, respectively along the direction IIIc-IIIc and along the direction IIIb-IIIb of FIG. 3a, FIG. 3d is a variant of FIG. 3c.

FIG. 4a illustrates a view of a transverse section of a cask according to the invention.

FIG. 4b illustrates a side view of a portion of the cask according to the invention.

FIG. 5 illustrates a perspective view of an assembly of casks assembled according to one embodiment of the invention.

FIGS. 6a to 6c represent, respectively, from the front, the side, and the top, a first embodiment of a storage unit integrating several casks.

FIGS. 7a to 7c represent, respectively, from the front, the side, and the top, a second embodiment of a storage unit integrating several casks, FIG. 7d showing the detail VIId of FIG. 7b, in an enlarged and more detailed manner.

### EXEMPLARY EMBODIMENT(S) OF THE INVENTION

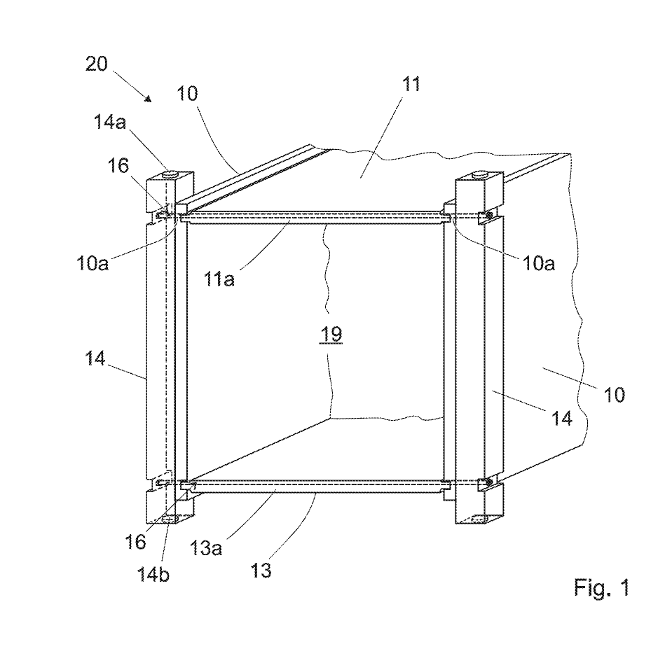

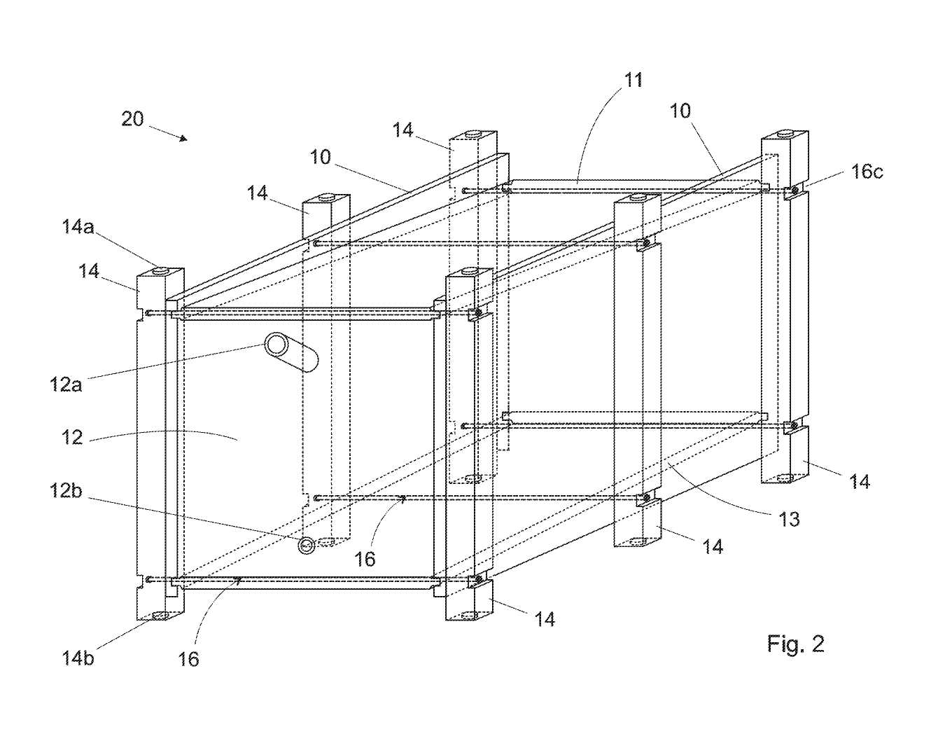

The cask 20 illustrated in FIGS. 1 to 6 comprises four lateral panels 10, 12, a lower panel 13 and an upper panel 11. The panels are formed of planar wooden boards, such as oak, and they define an approximately parallelepiped casing.

The panels define an interior volume 19 in which the liquid being stored is contained. The lower panel 13 may be inclined to facilitate the flow of the liquid through a drain hole 12b disposed at the front panel 12 near the lower panel 13. The front panel 12 also has a fill hole 12a, associated with a sleeve, situated near the upper panel 11. The upper panel 11 may be inclined to limit the surface of liquid in contact with the air, and thus the oxidation of the liquid when the cask is nearly full.

The panels are joined together by means of vertical beams 14 forming buttresses bearing against the external faces of the lateral panels 10. These buttresses limit the bending or stacking of the lateral panels 10 under the weight of the liquid contained in the volume 19. They can be beams of square section, such as wooden beams with a section of 30×30 or 40×40 or 50×50 mm², or stainless steel beams.

The vertical beams 14 are joined together in pairs by means of a compression element 16, each pair having two beams bearing against opposite panels. Each beam 14 exerts a force oriented toward the interior volume 19 of the cask. For example, the beam 14 exerts a force on the lateral panel 10 having at least one horizontal component oriented toward the internal volume 19 of the cask.

Each compression element 16 is disposed in a lower 13a or upper 11a through hole extending through a lower or upper panel 13, 11. For example, the compression element 16 of FIG. 1 exerts a horizontal compression force on the upper panel 11, via beams 14 and lateral panels 10 against which these beams are bearing.

The compression elements 16 passing through the panels 11, 13 also make it possible to rigidify them.

The six panels 10, 11, 12, 13 are fitted together by virtue of grooves and ribs forming tenon and mortise assemblies with complementary shape at the edges of the panels.

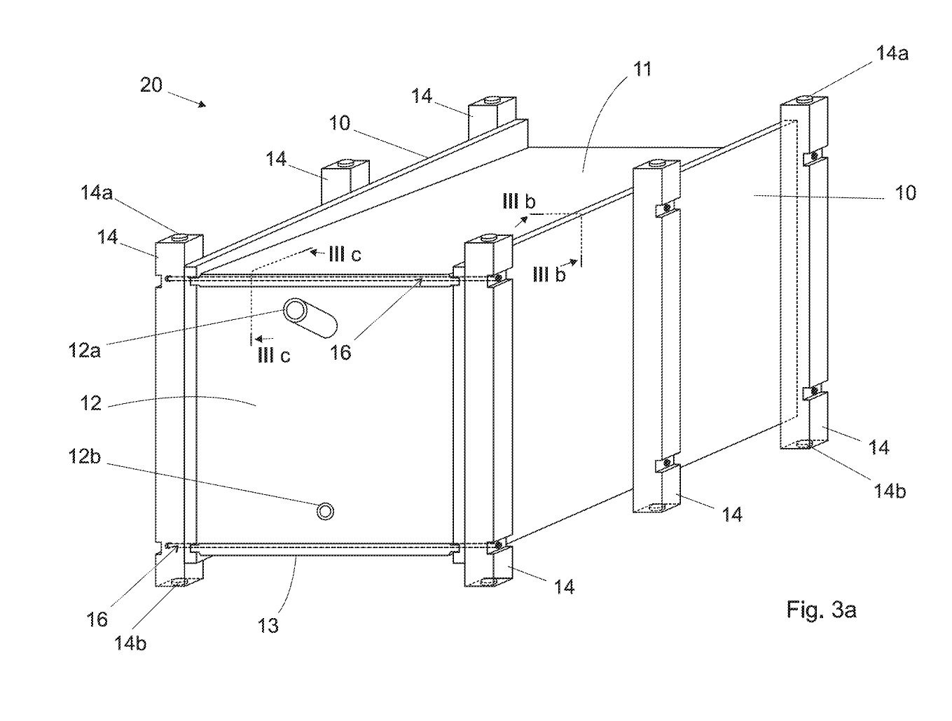

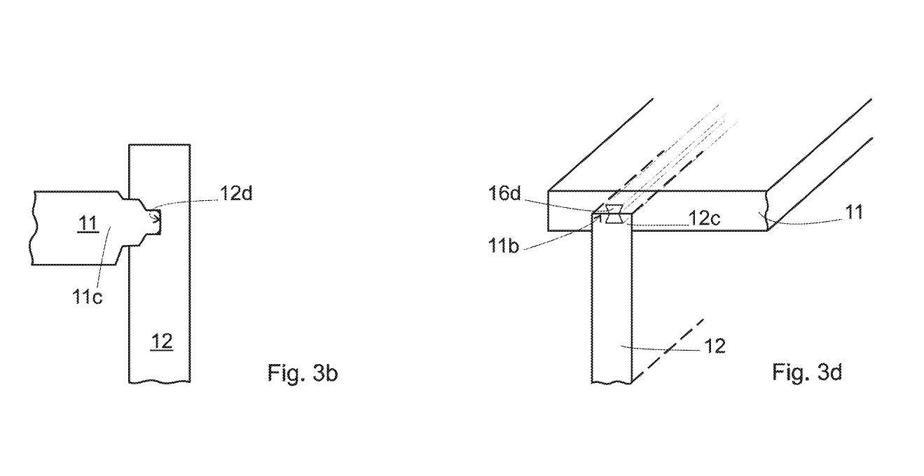

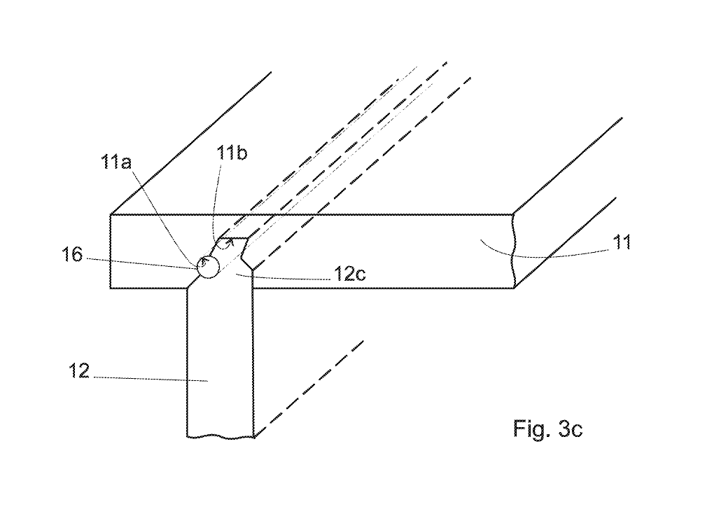

In the embodiment illustrated in FIG. 3a, the cask shown has six vertical beams 14 and six compression elements 16 joining these beams two by two. Different numbers of beams and compression elements may be considered.

Three beams 14 are disposed in an equidistant manner against the external face of each lateral panel 10 of the cask 20. A first pair of beams 14 and a pair of compression elements 16 are disposed near the front end face 12 of the cask 20, a second pair of beams 14 and a second pair of compression elements 16 are disposed near the rear face of the cask 20, and finally a third pair of beams 14 and a third pair of compression elements 16 are disposed at the middle of the lateral faces of the cask. The disposition of the beams near front and rear faces of the cask as well as at the middle of the panel makes it possible to distribute the forces over the panels, and to individually adjust the tension in the area of each corner of the cask 20. This front face and this rear face of the cask 20 are formed respectively on the lateral front panel 12 having the fill hole 12a and the drain hole 12b, and on the lateral rear panel 12.

According to a first possibility, the two compression elements 16 situated near the front end face and the rear face of the cask 20 do not reach the lateral front panel 12 and the lateral rear panel 12. In other words, in this case the compression elements 16 are not in contact with the lateral front and rear panels 12.

According to a second possibility, the two compression elements 16 situated near the front end face and the rear face of the cask 20 reach the lateral front panel 12 and the lateral rear panel 12 in the lower part and in the upper part. In other words, in this case the compression elements 16 are in contact with the lateral front and rear panels 12. For this purpose, as can be seen in FIG. 3c, the upper through hole 11a of the upper panel 11 is disposed along the mortise 11b of the upper panel 11 receiving the tenon 12c of the lateral front panel 12. In this case, the upper through hole 11a (lower through hole 13a) of the upper panel 11 (lower panel 13) is at the same time parallel with and emerges into the mortise 11b of the upper panel 11 (lower panel 13) designed to hold by form fit the corresponding tenon of the lateral front or rear panel 12. Thus, in this case, not only the compression element 16 serves for joining together two lateral panels 10 (side panels) with the upper 11 (lower 13) panel, but also it serves as a peg type locking element for the front and/or rear lateral panel 12. In this arrangement, the front and/or rear lateral panel 12 is thus held by the two compression elements 16 situated near the front end face of the cask 20 and optionally by the two compression elements 16 situated near the rear face of the cask 20. This results in an assembly between the two lateral panels 10 (side panels) and on the one hand the front (rear) lateral panel 12 and on the other hand the upper panel 11 and the lower panel 13. In one variant, which can be seen in FIG. 3d, instead of a compression element 16 having a rod 16a of circular section as in FIG. 3c, the compression element 16d has a rod whose section has a double dovetail shape; the mortise 11b of the upper panel and the tenon 12c of the front panel then have suitable complementary shapes to receive this double dovetail shape.

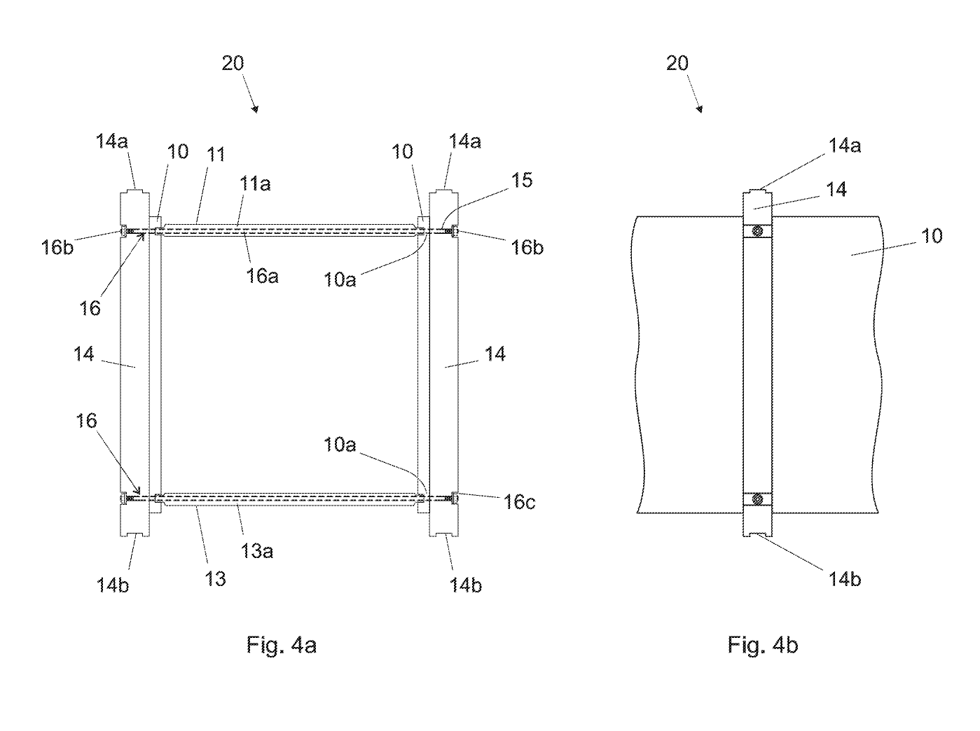

FIG. 4a shows a vertical section of the cask and FIG. 4b shows a side view of one portion of the cask. These figures illustrate one possible embodiment of the beams 14 bearing in this example against the lateral faces of the cask 20, on the left and right lateral panels 10 in FIGS. 1 to 6.

The longitudinal ends of each beam 14 have a tenon 14a at one of the ends and a mortise 14b complementary to the tenon 14a at the other end. The tenon 14a at the top of the beam 14 can thus cooperate by form fit with a mortise at the bottom of a beam placed on top of it, which allows a precise positioning and holding together of the cask with the one placed below it. It is also possible to invert the position of the tenon and the mortise.

A through hole 15, such as a through hole adapted to receive rods of diameter M10, is made in the upper and lower end portions of the bar of each beam 14, in a horizontal direction perpendicular to this beam 14, in order to receive the end of the compression element 16, as explained below.

FIG. 4a illustrates a detailed view of the assembly of a beam 14 with a compression element 16. In this example, the beam 14 is provided with a through hole 15, for example, a nonthreaded hole of diameter 12 mm. The compression element 16 in this example consists of a rod 16a of circular section with diameter M12, threaded at its two ends, and two nuts 16b. A washer may be provided beneath each nut. This compression element 16 is engaged in the hole 15 emerging from the beam 14; in a through hole 10a passing through the vertical panel (lateral panel 10) and in the lower 13a or upper 11a through hole extending between two opposite sides of the lateral panels 10 without reaching the internal volume 19. Other compression elements may also be used, for example, a tube threaded at its ends and two fixation screws engaged at each end, etc. The vertical beams have a milled area 16c sufficiently deep to accommodate the head of the screws or nuts at each end of the compression means, in order to allow the juxtapositioning of two casks whose vertical beams 14 bear against each other.

The person skilled in the art will understand that vertical beams of non-rectangular or square section may also be used.

FIG. 4a also illustrates one possible profile for the assembly of the panels 10 and 11 in tongue and groove manner. It enables a simple assembly of the panels by fitting them together. Similar fitting profiles, in stairway fashion, can also be used to assemble adjacent orthogonal panels together.

According to the invention, it is possible to stack several casks 20 as described above on each other. The weight of the superposed casks 20 bears against the ends of the vertical beams 14 of the casks of the lower tiers; these beams 14 may be dimensioned for very heavy loads, and their large section as well as the system of centering by tenon and mortise guarantees the stability of the assembly.

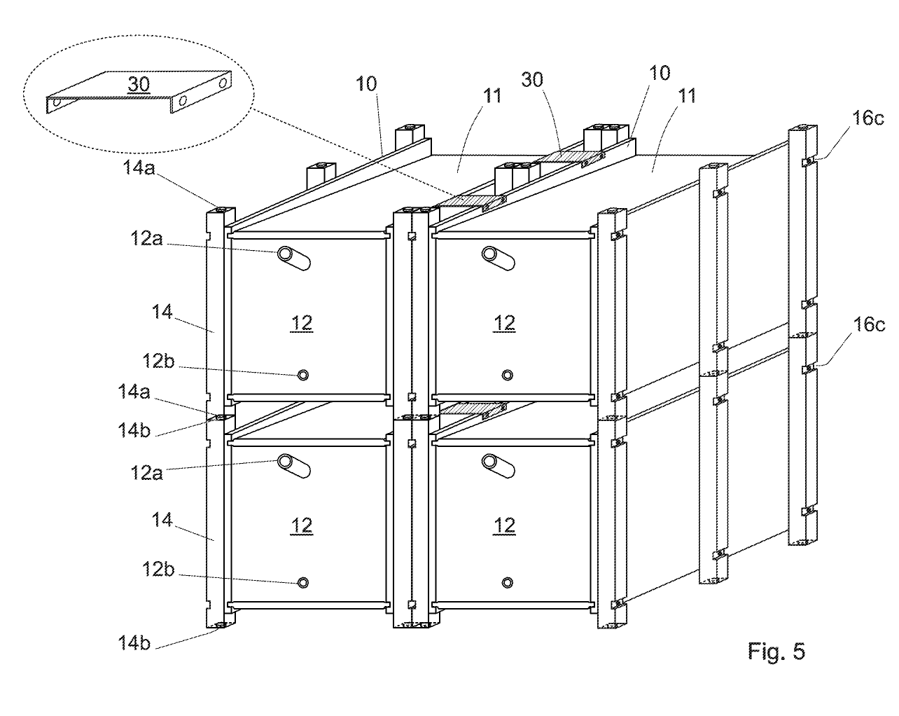

The juxtaposed casks 20 can be maintained side by side by lateral linkage elements, such as U-shaped metal links 30 mounted upside down and astride the upper edge of a lateral panel 10 of each cask. FIG. 5 illustrates for example two stacks, each stack comprising two superposed casks held against the other neighboring stack by means of these U-shaped irons 30. The width of the U shapes 30 may be adjustable to bring the casks closer together.

The spacing between the superposed casks 20 is determined by the length of the beams 14 which, by extending beyond the height of the lateral panels 10, makes it possible to create a space accessible between the casks. In the aforementioned example, this spacing is 10 cm, but it may vary between 1.0 and 25 cm, preferably between 2.0 and 20 cm, advantageously between 4.0 and 15 cm. This spacing allows for easier handling of the casks, easier access to the casks with a forklift, a fork or some other suitable device, and furthermore an air flow around the entire perimeter of the cask 20.

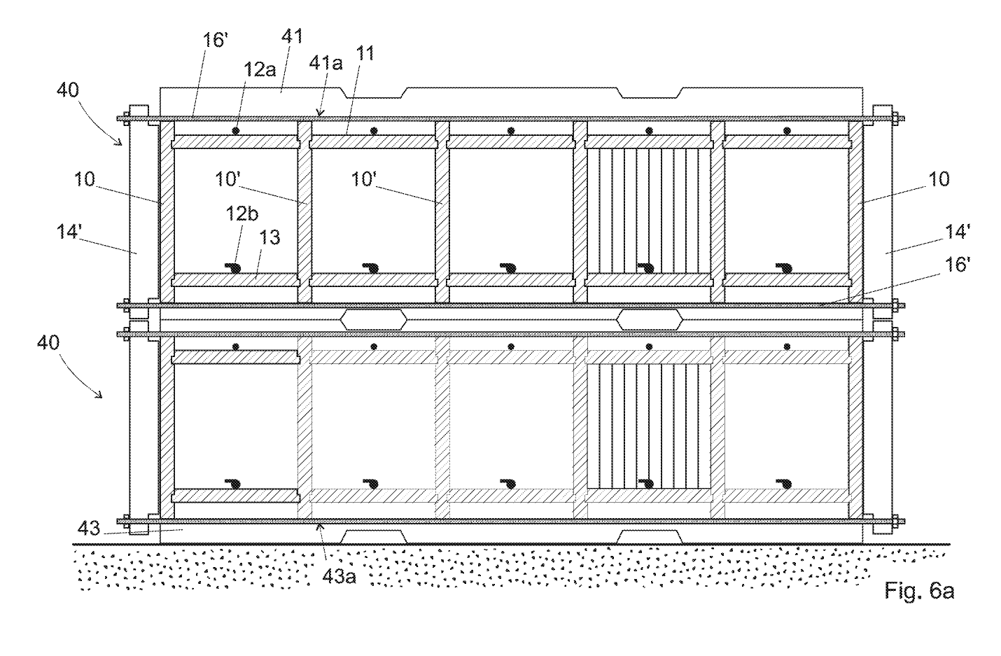

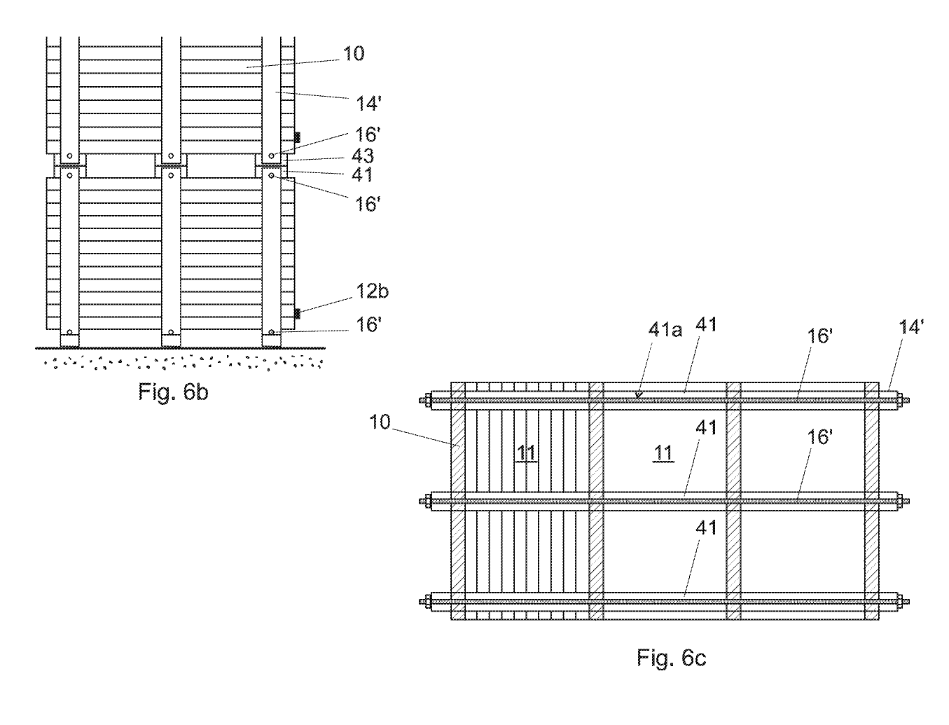

Turning now to FIGS. 6a to 6c, which represent two storage units 40 according to a first embodiment. Each storage unit 40 comprises n casks 20′ aligned side by side with n varying between 2 and 10 casks 20′ (n=5 in FIG. 6a).

In order to form this storage unit 40 of five casks 20′, one uses five lower panels 13, five upper panels 11, five lateral panels 12 forming the front wall, five lateral panels 12 forming the rear wall, as well as six (and not ten) lateral panels 10, 10′ forming the left or right wall. In fact, there are two lateral panels 10 forming the outside of the storage unit 40 which serve as lateral panels for a single cask 20′, whereas the other (four) lateral panels 10′ serve as an intermediate separation common to two neighboring casks 20′. Thus, it will be understood that since these intermediate panels 10′ serve as both the lateral left wall for one of the two neighboring casks and lateral right wall for the other of the neighboring casks, they constitute a lateral panel common to the two adjacent casks, and thus one achieves a saving on raw material.

In this first embodiment, the six vertical beams 14 dedicated to each cask 20 have been replaced by six vertical beams 14′ dedicated to each storage unit 40. These six vertical beams 14′ are mounted in pairs against the external face of each lateral panel 10 directed toward the outside of the storage unit 40: three vertical beams 14′ are mounted against the external face of one of these two lateral panels 10 and the other three vertical beams 14′ are mounted against the external face of the other of these two lateral panels 10. In the present case, the two ends of said vertical beams 14′ extend beyond the lower edges and the upper edges of the lateral panel 10 against which they are mounted.

In order to stabilize and hold in place the panels 10, 10′, 11, 12 and 13 and the vertical beams 14′, while maintaining the tightness of each cask 20′, one further utilizes two horizontal bars 41 and 43, preferably made of wood (slats), and two compression elements 16′ for each pair of vertical beams 14′. The horizontal bars 41 are mounted on top of the n casks 20′, bearing against the upper ends of the lateral panels 10 and 10′. The horizontal bars 43 are mounted beneath the n casks 20′, bearing against the lower ends of the lateral panels 10 and 10′. Here, the compression elements 16′ make it possible to join together the ends of the vertical beams 14′ by passing through the horizontal bars 41, 43 to accomplish a strapping around the n casks. In the case of the figure illustrated in FIGS. 6a to 6c, a first strapping is accomplished in the front portion of the storage unit 40, a second strapping is accomplished rear portion of the storage unit 40, and a third intermediate strapping is accomplished between the front portion and the rear portion of the storage unit 40.

As one can see in FIGS. 6a and 6c, the compression elements 16′ here are rods threaded at their two ends associated with two nuts 16b. The two rods used for one strapping are disposed in the hole emerging 15′ at the end of the two vertical beams 14′ situated facing each other on either side of the outer lateral panels 10, and extending in an upper 41a or lower 43a through hole from one end to the other of the horizontal bars 41 and 43, respectively.

The placement of one storage unit 40 on top of another is done by the fact that the lower face of the lower horizontal bars 43 of the upper storage unit 40 rests on the upper face of the upper horizontal bars 41 of the lower storage unit 40. In the example illustrated in FIGS. 6a to 6c, the vertical beams 14′ extend beyond the lower and upper edges of the lateral panel 10′ against which they are mounted, yet they remain below the external faces of the horizontal bars 41, 43. According to two other variants, not illustrated, one may arrange vertical beams 14′ extending beyond the lower and upper edges of the lateral panel 10′ against which they are mounted, and extending at the same height as the external faces of the horizontal bars 41 (and/or 43) or extending vertically and passing beyond the external faces of the horizontal bars 41 (and/or 43) (in this case, the lower face of the lower horizontal bars 43 of the upper storage unit 40 does not rest on the upper face of the upper horizontal bars 41 of the lower storage unit 40, but rather is distant from it). For these two variants, when placing the storage units 40 on one another, the vertical beams 14′ situated in line with each other are bearing against each other.

Thus, in the case of the first embodiment of the storage unit 40 according to the invention, it will be understood that a reduced number of vertical beams 14′ is used as compared to the number of vertical beams 14 used for independent casks, such as those previously described in relation to FIGS. 1 to 5. In fact, for the storage unit 40 shown, consisting of five casks 20′, one uses six vertical beams 14′, whereas with five independent casks 20 one uses thirty vertical beams 14.

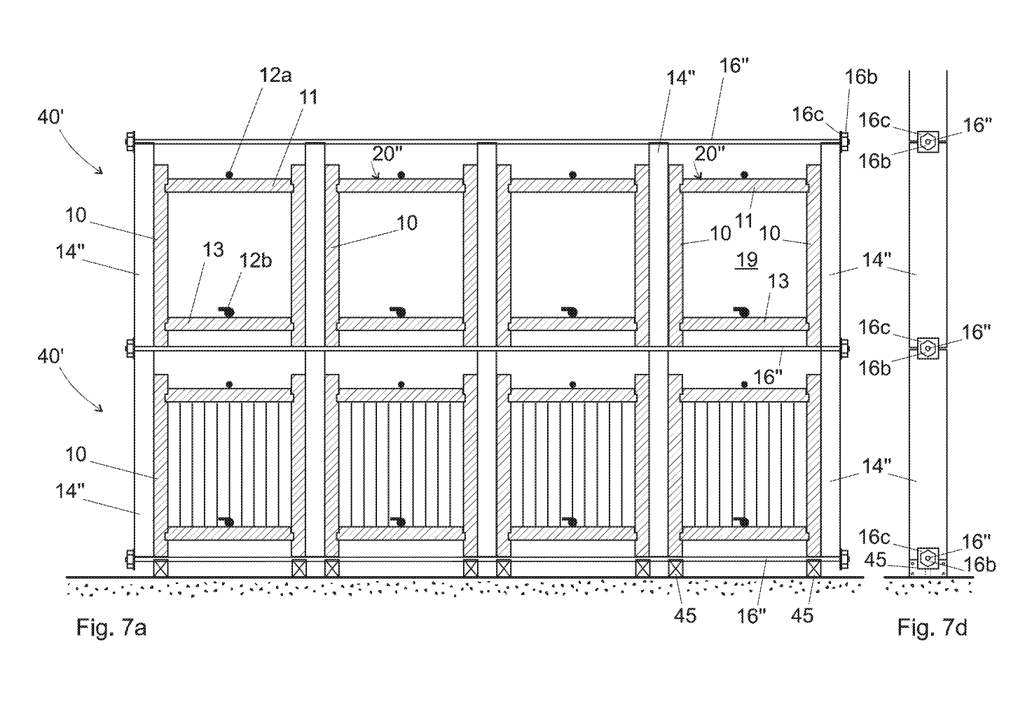

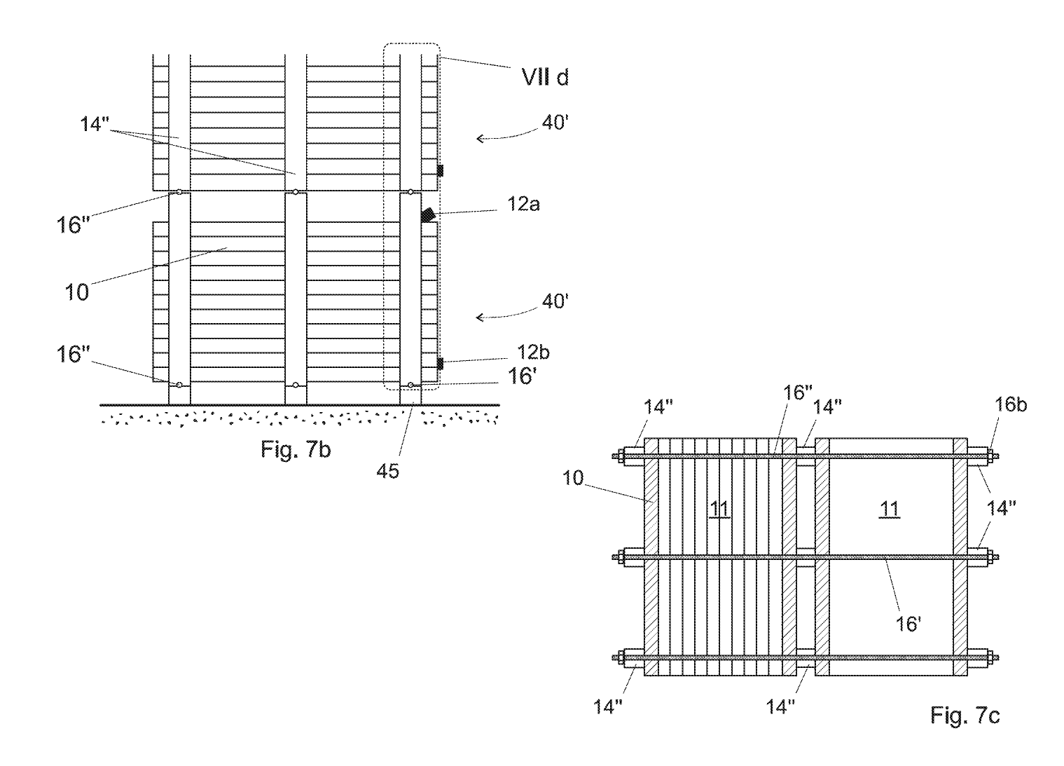

Turning now to FIGS. 7a to 7d, which represent two storage units 40′ according to a second embodiment, placed one on top of another. Each storage unit 40′ is composed of n casks 20″ aligned side by side with n varying between 2 and 10 casks 20″ (n=4 in FIG. 7a). As for the independent casks 20 previously described, the casks 20″ each have four lateral panels 10, 12, a lower panel 13 and an upper panel 11, and no lateral panel in common with the neighboring cask 20″.

In order to form this storage unit 40′ of four casks 20″, so as to hold together the n casks and keep them tight by placing the two opposite lateral panels 10 under compression, one uses vertical beams 14″ which are longer than the height of the lateral panels 10 and compression elements 16″. One uses three series of vertical beams 14″ (one toward the front of the casks 20″, the other toward the rear of the casks 20″ and another one between the front and the rear of the casks 20″) and in each series one places a single vertical beam 14″ between each pair of two neighboring casks (in contact with the two closest lateral walls of two neighboring casks), but also one outer vertical beam 14″ placed in the direction of the outside of the storage unit 40′ and forming the external lateral wall of the storage unit 40′. One uses compression elements 16″ extending for the entire width of the storage unit 40′, between said outer vertical beams 14″.

In this second embodiment, the compression elements 16″ are disposed at the lower end and at the upper end of the vertical beams 14″, the latter having a groove able to accommodate the corresponding piece of the compression element 16″. More precisely, the compression element 16″ is composed, in the example illustrated in FIGS. 7a to 7d, of a rod 16a threaded at its two ends, two nuts 16b, and two washers 16c, one washer being provided beneath each nut 16b, bearing against the external face of the outer vertical beams 14″. In this way, thanks to the nuts 16b and the washers 16c, the ends of the threaded rod 16a are held against the external face of the outer vertical beams 14″, which allows the threaded rod to be placed under compression.

Thus, in the case of the second embodiment of the storage unit 40′ according to the invention, it will be understood that one also utilizes a reduced number of vertical beams 14″ as compared to the number of vertical beams 14 used for independent casks such as those previously described in relation to FIGS. 1 to 5. In fact, for the storage unit 40′ shown, containing four casks 20′, one uses fifteen vertical beams 14″, whereas with five independent casks 20 one uses twenty four vertical beams 14.

When placing two storage units 40′ one on the other, one stacks the vertical beams 14″ on each other, the lower end of the vertical beams 14″ is placed at the same height as the lower end (or lower edge) of the lateral panels 10, 12, whereas the upper end of the vertical beams 14″ is situated higher than the upper end of the lateral panels 10, 12, namely, the upper end of the vertical beams 14″ passes beyond the upper edge of the lateral panels 10, 12.

As can be seen in FIG. 7a, which shows the situation with two superposed storage units 40′, one uses compression elements 16″ on top, at the middle, and at the bottom of the stack so formed. This situation corresponds to the presence of compression elements 16″ above the upper end of the vertical beams 14″ of the upper storage unit 40′, below the lower end of the vertical beams 14″ of the lower storage unit 40′, and also between the lower end of the vertical beams 14″ of the upper storage unit 40′ and the upper end of the vertical beams 14″ of the lower storage unit 40′. In order to support the compression elements 16″ situated beneath the lower end of the vertical beams 14″ of the lower storage unit 40′ and protect them from contact with the ground, one uses wedges 45 placed in line with the vertical beams 14″ and likewise having a groove able to lodge the corresponding piece of the compression element 16″ which is below the lower end of the vertical beams 14″ of the lower storage unit 40′.

For the first embodiment and for the second embodiment, the assembly between the panels 10, 10′, 11, 12 and 13, as in the case of the cask 20 of FIGS. 1 to 4, is realized by fitting together grooves and corresponding ribs, forming mortise and tenon assemblies with form fit at the edges of the panels in contact two by two, in order to bound between six panels 10, 10′, 11, 12 and 13 an internal volume 19 of parallelepiped shape.

Likewise, each storage unit 40 and 40′ forms an autonomous and compact module, able to be placed on top of another storage unit 40 to form a storage assembly of 2×n casks, or of m×n casks when using m storage units 40 or 40′.

For the first embodiment and for the second embodiment of the storage unit, as illustrated respectively in FIGS. 6a-6c and 7a-7d, the fill hole 12a associated with a fill sleeve is situated on the upper panel 11, near the front panel 12. As a variant, the cask 20 of FIGS. 1 to 5 may likewise have its fill hole (sleeve) 12a situated on the upper panel 11, near the front panel 12.

### REFERENCE NUMBERS USED IN THE FIGURES

10 lateral panel left or right
10′ lateral panel left or right
10a through hole
11 upper panel
11a upper through hole
11b mortise
11c tenon
12 lateral panel front or rear
12a fill hole
12b drain hole
12c tenon
12d mortise
13 lower panel
13a lower through hole
14 vertical beam
14′ vertical beam
14″ vertical beam
14a tenon
14b mortise
15 through hole
16 compression element (rod of circular section)
16′ compression element (rod of circular section)
16″ compression element (rod of circular section)
16a threaded rod
16b nut
16c washer
16d compression element (rod of double dovetail section)
19 internal volume of cask 20
20 cask
20′ cask
20″ cask
30 U-shaped iron
40 storage unit (first embodiment)
40′ storage unit (second embodiment)
41 upper horizontal bar
41a upper through hole
43 lower horizontal bar
43a lower through hole
45 wedge

What is claimed is:

1-25. (canceled)

26. A wooden cask for the storing and aging of wines and other beverages, comprising:
four lateral panels defining an upper edge and a lower edge;
a lower panel;
an upper panel;
wherein said lateral panels, said lower panel and said upper panel are provided with external and internal substantially planar faces and are assembled together so as to define an internal storage volume,
vertical beams having two ends and forming a buttress against the external faces of at least two opposite lateral panels, wherein said two ends of said vertical beams extend beyond the lower and upper edges of the lateral panel against which said vertical beams are mounted, wherein each vertical beam is connected to another vertical beam bearing against the external face of an opposite lateral panel, forming thereby a pair of associated vertical beams, and
at least two compression elements, wherein each vertical beam end is connected to another vertical beam end of a pair of associated vertical beams by means of at least one compression element able to exert an horizontal force tending to bring together said opposite vertical beams of a pair of associated vertical beams and said opposite lateral panels against which these two beams rest, and wherein each of said compression elements passes through one of said lower panel and said upper panel.

27. The wooden cask as claimed in claim 26, wherein said vertical beams extend between 0.5 and 12.5 cm beyond the lower edge and upper edge of said lateral panel against which said vertical beams are mounted.

28. The wooden cask as claimed in claim 26, comprising at least two said vertical beams bearing against each such opposite lateral panel.

29. The wooden cask as claimed in claim 26, wherein each said compression element passes through the width of one of said lower panel and upper panel without reaching said internal volume of the cask.

30. The wooden cask as claimed in claim 26, in which at least one of said compression elements is furthermore devised to hold one of said lateral front panel and rear panel with respect to one of said upper panel and lower panel.

31. The wooden cask as claimed in claim 26, wherein each end of said vertical beams is pierced by a horizontal through hole and wherein said compression elements pass through said through holes.

32. The wooden cask as claimed in claim 26, wherein each compression element comprises a tube threaded at its ends and two fixation screws screwed to each end of the tube.

33. The wooden cask as claimed in claim 26, wherein the compression element comprises a threaded rod and two nuts screwed to each end of said threaded rod.

34. The wooden cask as claimed in claim 26, wherein said vertical beams comprise a first end with a tenon and a second end with a mortise having a shape complementary to the tenon.

35. The wooden cask as claimed in claim 26, wherein said four lateral panels, said lower panel and said upper panel from a series of six panels which are fitted together.

36. An assembly of casks comprising at least two casks as claimed in claim 26, wherein said casks are held together side by side by at least one U-shaped element arranged upside down astride the edge of a lateral panel of each cask.

37. A wooden storage unit bounding a series of several casks for the storing and aging of wines and other beverages, each cask comprising:
four lateral panels;
a lower panel;
an upper panel;
wherein said lateral panels, said lower panel and said upper panel are provided with external and internal substantially planar faces and are assembled together so as to define an internal storage volume,
said casks forming a series of several casks adjacent and aligned with each other,
said storage unit further comprises at least two vertical beams forming a pair of associated outer vertical beams, wherein said vertical beams have two ends and form a buttress against the external faces of the two opposite lateral panels of the storage unit directed toward the outside of the storage unit, wherein said two ends of said vertical beams extend beyond at least one of the lower edge and the upper edge of the lateral panel against which they are mounted, and
said storage unit further comprises at least two compression elements, wherein each vertical beam end is connected to another vertical beam end of a pair of associated outer vertical beams by means of at least one compression element able to exert an horizontal force tending to bring together said opposite vertical beams of a pair of associated outer vertical beams and said opposite lateral panels against which these two beams rest.

38. The storage unit as claimed in claim 37, wherein in each pair of opposite vertical beams are joined together by two compression elements.

39. The storage unit as claimed in claim 37, wherein said adjacent casks have a lateral panel in common for the two adjacent casks.

40. The storage unit as claimed in claim 37, wherein said storage unit further comprises horizontal bars disposed above and below all the lateral panels, said horizontal bars being disposed between two vertical beams of a pair of associated outer vertical beams.

41. The storage unit as claimed in claim 40, wherein said compression elements furthermore pass through said horizontal bars.

42. The storage unit as claimed in claim 37, wherein said storage unit furthermore comprises vertical common beams, said adjacent casks of a pair of adjacent casks being separated from each other by a common vertical beam whose two opposite faces are in contact with said two adjacent casks.

43. The storage unit as claimed in claim 37, wherein each of the two ends of said vertical beams is assembled to the other of said two ends of said vertical beams by a compression element.

44. The storage unit as claimed in claim 37, wherein said compression elements are lodged in grooves formed at least in one end of the vertical beams.

45. The storage unit as claimed in claim 37, wherein said storage unit furthermore comprises vertical common beams, said adjacent casks of a pair of adjacent casks being separated from each other by a common vertical beam whose two opposite faces are in contact with said two adjacent casks, wherein the outer vertical beams and the common vertical beams are able to be arranged in vertical alignment and placed beneath or on top of one of said outer vertical beams and of said common vertical beams of another storage unit during the stacking between at least two storage units.
